(19) United States
(12) Patent Application Publication
(10) Pub. No.: US 2019/0137387 A1
(43) Pub. Date: May 9, 2019

(54) DEVICE

(71) Applicant: Panasonic Intellectual Property Management Co., Ltd., Osaka (JP)

(72) Inventors: MASAHIKO OHBAYASHI, Osaka (JP); KOJI SAKAI, Hyogo (JP); RYOSUKE MESHII, Osaka (JP); SHINICHI KISHIMOTO, Osaka (JP); AKIRA MATSUURA, Osaka (JP)

(21) Appl. No.: 16/096,287

(22) PCT Filed: May 16, 2017
(86) PCT No.: PCT/JP2017/018314

§ 371 Date: Oct. 25, 2018

(30) Foreign Application Priority Data
May 25, 2016 (JP) 2016-103820

(51) Int. Cl. G01N 21/3504; G01N 21/03; G01N 21/552

(52) U.S. Cl. CPC G01N 21/3504; G01N 21/552; G01N 21/0303

(57) ABSTRACT

An object of the present disclosure is to provide a device that can be manufactured in a simple process while ensuring a reduction in influence of noise on an electronic component. A device according to the present disclosure, accomplished to fulfill the object, includes light emitting element, light receiving element, electronic component to process signals sent from light receiving element, and optical component cover light emitting element and light receiving element. The device further includes reflector cover a lower surface of optical component and substrate. Reflector has first opening directly above light emitting element and second opening directly above light receiving element. Light emitting element, light receiving element, reflector, electronic component, and optical component are mounted over substrate. Reflector is electrically connected to substrate by a member disposed between reflector and substrate.

### TECHNICAL FIELD

The present disclosure relates to a device such as a fluid constituent detector that detects a concentration of a fluid constituent using infrared ray or other light absorption characteristics.

### BACKGROUND ART

PTL 1 and PTL 2 disclose devices that serve as sensors for detecting concentrations of fluids. It is known that such conventional sensors detect concentrations of fluids by transmissivity of light being emitted from light emitting elements and being received by light receiving elements.

### CITATION LIST

### Patent Literature

PTL 1: WO 2014/136414

PTL 2: Unexamined Japanese Patent Publication No. 2012-177690

### SUMMARY OF THE INVENTION

However, electronic components are incorporated in these devices. If the electronic component is influenced by noise, the accuracy of the device in detecting a fluid constituent decreases. An attempt to reduce influence of the noise disadvantageously complicates a process of manufacturing the device.

An object of the present disclosure, accomplished to solve the above-described challenge, is to provide a device that can be manufactured in a simple process while ensuring a reduction in noise influence.

A device according to the present disclosure, accomplished to solve the above-described challenge, includes a light emitting element, a light receiving element, an electronic component to process signals sent from the light receiving element, and an optical component cover the light emitting element and the light receiving element. The device further includes a reflector cover a lower surface of the optical component and a substrate. The reflector has a first opening facing the light emitting element and a second opening facing the light receiving element. The light emitting element, the light receiving element, the reflector, the electronic component, and the optical component are mounted over the substrate. The reflector is electrically connected to the substrate by a member disposed between the reflector and the substrate.

The configuration of the device described above according to the present disclosure enables the reflector to have a shield effect and thus contributes to a reduction in the influence of noise on the electronic component.

### BRIEF DESCRIPTION OF DRAWINGS

FIG. 1 is an exploded perspective view of a device according to a first exemplary embodiment of the present disclosure.

FIG. 2 is a perspective view of the device.

FIG. 3 is a top view of the device.

FIG. 4 is a cross-sectional view of the device taken from line IV-IV.

FIG. 5 is an exploded perspective view of a device according to a second exemplary embodiment of the present disclosure.

FIG. 6 is a perspective view of the device.

FIG. 7 is a top view of the device.

FIG. 8 is a cross-sectional view of the device taken from line VIII-VIII.

FIG. 9 is an exploded perspective view of a device according to a third exemplary embodiment of the present disclosure.

FIG. 10 is a perspective view of the device.

FIG. 11 is a top view of the device.

FIG. 12 is a cross-sectional view of the device taken from line XII-XII.

FIG. 13 is an exploded perspective view of a device according to a fourth exemplary embodiment of the present disclosure.

FIG. 14 is a perspective view of the device.

FIG. 15 is a top view of the device.

FIG. 16 is a cross-sectional view of the device taken from line XVI-XVI.

FIG. 17 is an exploded perspective view of a device according to a fifth exemplary embodiment of the present disclosure.

FIG. 18 is a perspective view of the device.

FIG. 19 is a side view of the device.

FIG. 20 is a top view of the device.

FIG. 21 is a cross-sectional view of the device taken from line XXI-XXI.

### DESCRIPTION OF EMBODIMENTS

Control devices for use in vehicles, according to exemplary embodiments of the present disclosure, will be described below with reference to the drawings. In the drawings, identical or equivalent components are denoted by identical reference signs, and redundant descriptions thereof will be omitted. Components in the exemplary embodiments may be freely combined within a scope in which no contradiction arises. Various modifications may be made to the exemplary embodiments insofar as they are within the scope of the present invention.

### First Exemplary Embodiment

Device 1 according to a first exemplary embodiment will now be described with reference to the drawings.

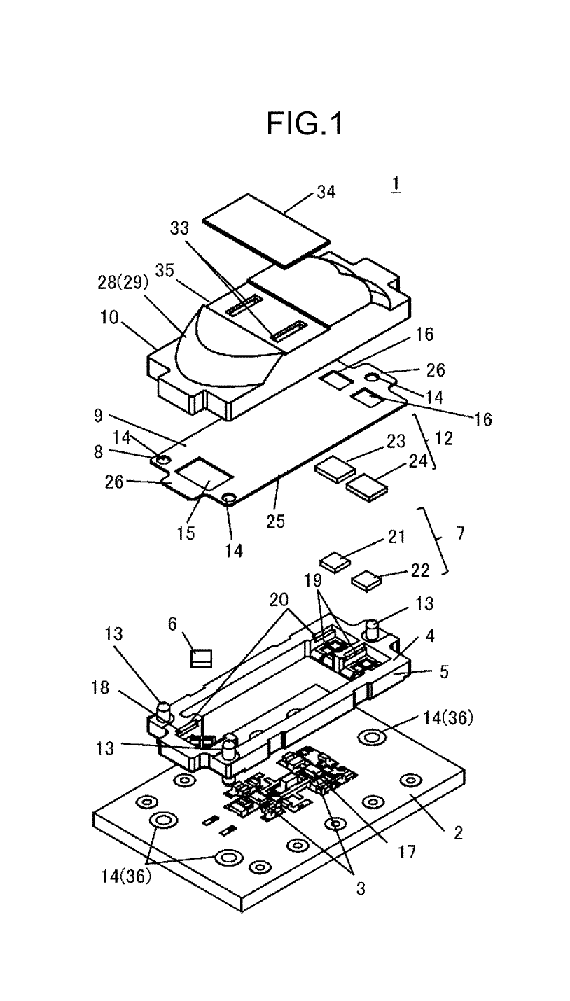

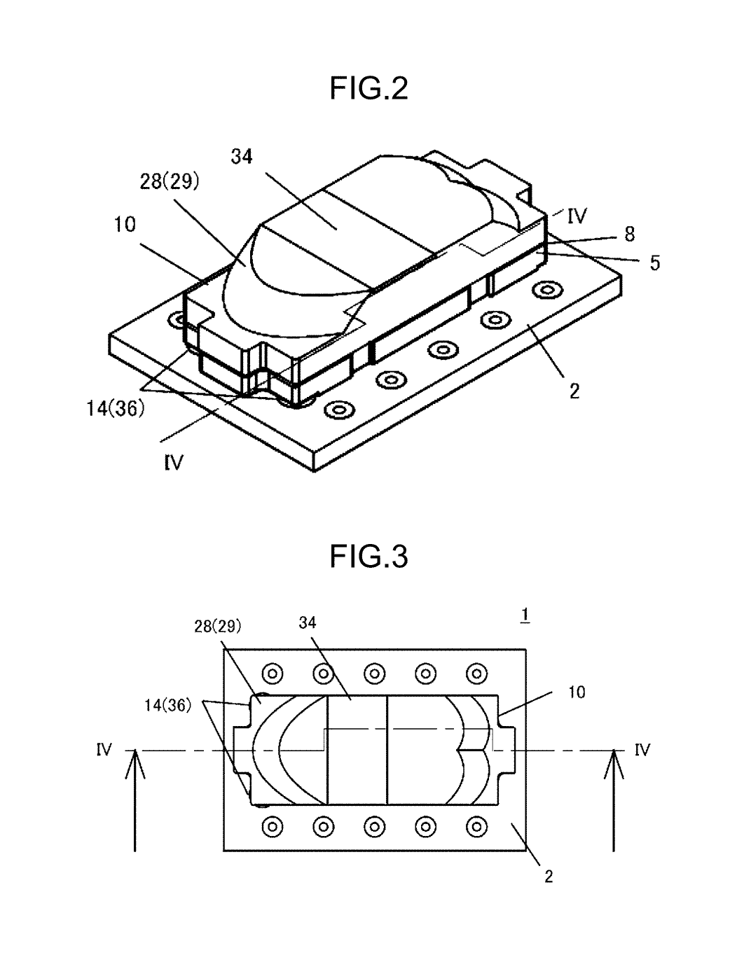

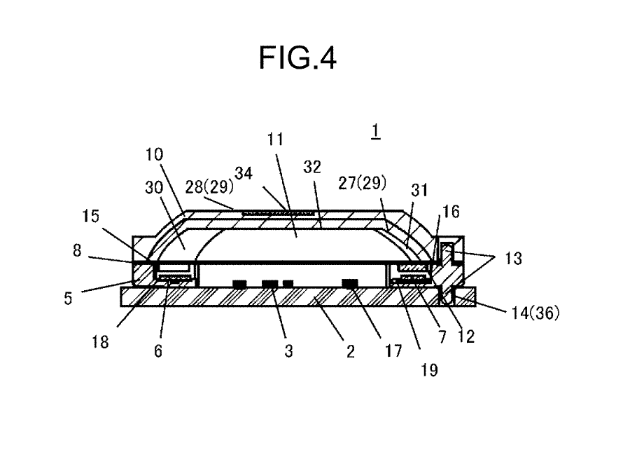

FIG. 1 is an exploded perspective view of device 1 according to the first exemplary embodiment. FIG. 2 is a perspective view of device 1. FIG. 3 is a top view of device 1. FIG. 4 is a cross-sectional view of device 1 taken from line IV-IV.

With reference to FIGS. 1 to 4, device 1 includes substrate 2, electronic component 3 disposed on substrate 2, support 5 being disposed so as to surround electronic component 3 and having upper surface 4, light emitting element 6 and light receiving element 7 that are disposed on support 5, reflector 8 disposed on upper surface 4 of support 5, and optical component 10 disposed on upper surface 9 of reflector 8. Device 1 further includes optical filter 12 disposed in optical path 11 guiding infrared rays emitted from light emitting element 6 toward light receiving element 7. Infrared rays in a predetermined wavelength band are permitted to pass through optical filter 12. Support 5 is provided with projections 13. Substrate 2, reflector 8, and optical component 10 each have insertion holes 14. Projections 13 are inserted into insertion holes 14 in substrate 2, reflector 8, and optical component 10, and these components are fastened by soldering (not shown). Projections 13 enable substrate 2, reflector 8, and optical component 10 to be put in proper alignment with support 5. Projection 13 is hemispheric in tip shape and cylindrical in overall shape. Light emitting element 6 is interposed between projections 13 in planar view. Two projections 13 are disposed near one end of support 5, and one projection 13 is disposed near another end of the support. Support 5 may have insertion holes 14 without projections 13. Thus, pins may be inserted into insertion holes 14 in each of the components so that these components are fastened. In planar view, light emitting element 6 is disposed near one end of optical component 10, whereas light receiving element 7 is disposed near another end that is opposite to the one end of optical component 10. Reflector 8 has first opening 15 that is disposed directly above light emitting element 6 and second opening 16 that is disposed directly above light receiving element 7. In reflector 8, first opening 15 may be disposed so as to face light emitting element 6 other than directly above light emitting element 6. In reflector 8, second opening 16 may be disposed so as to face light receiving element 7 other than directly above light receiving element 7.

Substrate 2 is formed of a glass epoxy resin substrate having a rectangular flat shape. A surface of substrate 2 is provided with a conductive pattern of traces. A plurality of electronic components 3 is mounted on the surface of substrate 2. Electronic components 3 are electrically connected to the conductive pattern by soldering (not shown). The plurality of electronic components 3 is electrically connected with each other by the conductive pattern formed on substrate 2. The plurality of electronic components 3 constitutes signal processing circuit 17. Signal processing circuit 17 controls light emitting element 6 to emit infrared rays. Signal processing circuit 17 is configured to process signals sent from light receiving element 7 that has received infrared rays. Signal processing circuit 17 performs signal processing such as amplification of a signal sent from light receiving element 7, waveform shaping, signal sampling, and analogue-digital (AID) conversion of a signal. Signal processing circuit 17 also performs signal processing such as computing intensity of a signal, correcting a signal, and determining whether or not a concentration of a subject gas is outside a range. Support 5 disposed on substrate 2 is a synthetic resin molded part forming a rectangular frame in external shape. Signal processing circuit 17 is disposed inside an opening in support 5. Entire device 1 can come down in size owing to the disposition of electronic components 3 that constitute signal processing circuit 17 inside the opening in frame-shaped support 5. Substrate 2 may be formed of a ceramic multilayer substrate, for example, other than the glass epoxy resin substrate.

The opening in support 5 exposes the surface of substrate 2. First recess 18 is formed in a first end part of a position surface of support 5. In support 5, light emitting element 6 is mounted on an inner bottom surface of first recess 18. Device 1 has light emitting element 6, which is mounted on the inner bottom surface of first recess 18 by a die bond agent (not shown). In device 1, the conductive pattern formed on the surface of substrate 2 is electrically connected to light emitting element 6 by a wire-bonded metal wire. Light emitting element 6 is formed of a light-emitting diode capable of emitting infrared rays. The light-emitting diode is made of a semiconductor bare chip. Light emitting element 6 emits infrared rays of a wavelength that is readily absorbed by a gas subject to detection. Examples of the gas subject to detection include carbon monoxide, carbon dioxide, methane, and nitrogen oxides. Light emitting element 6 is mounted in first recess 18 of support 5. This prevents the light emitting element and the signal processing circuit formed on substrate 2 from having a thermal influence on each other. Second recess 19 is formed in a second end part opposite to the first end part of the position surface of support 5. In support 5, light receiving element 7 is mounted on an inner bottom surface of second recess 19. Device 1 has light receiving element 7, which is mounted on the inner bottom surface of second recess 19 by a die bond agent (not shown). In device 1, the conductive pattern formed on the surface of substrate 2 is electrically connected to light receiving element 7 by a wire-bonded metal wire (not shown). Light receiving element 7 is formed of an infrared sensor capable of receiving infrared rays. The infrared sensor is made of a pyroelectric element. The infrared sensor is a semiconductor bare chip. Support 5 supports light emitting element 6 and light receiving element 7 on its position surface, with a predetermined space provided between the elements. The light-emitting diode may be made of a chip-sized package other than the bare chip. Light emitting element 6 may be made of a light emitting diode chip, or a resistive element or a laser diode formed on a semiconductor substrate, for example. Light receiving element 7 may be made of a chip-sized package other than the semiconductor bare chip. Light receiving element 7 may be a pyroelectric element or a photodiode chip, for example. However, light emitting element 6 and light receiving element 7 that are made of bare chips allow entire device 1 to come down in size.

Support 5 has step parts 20 on opposed inner walls of second recess 19.

In support 5, optical filter 12 is disposed on a pair of step parts 20 so as to cover light receiving element 7. A depth of step part 20 in a thickness direction of support 5 is substantially equal in size to a thickness of optical filter 12. Optical filter 12 is formed of a bandpass filter having a light transmission range. A predetermined band of wavelengths out of the wavelengths of infrared rays emitted from light emitting element 6 falls within the light transmission range.

Device 1 according to the present exemplary embodiment includes a pair of second recesses 19 formed in the second end part of upper surface 4 of support 5. In support 5, light receiving elements 7 are mounted on inner bottom surfaces of respective second recesses 19. In device 1, optical filters 12 are disposed for respective light receiving elements 7 so as to cover a pair of light receiving elements 7 (hereinafter also referred to as first light receiving element 21 and second light receiving element 22).

In device 1, one optical filter 12 out of optical filters 12 provided for respective light receiving elements 7 is first optical filter 23 having a light transmission range. A wavelength range of infrared rays absorbed by a gas subject to detection falls within the light transmission range. In device 1, other optical filter 12 out of optical filters 12 provided for respective light receiving elements 7 is second optical filter 24 having a light transmission range. The wavelength range of infrared rays absorbed by the gas subject to detection does not fall within the light transmission range, but wavelengths close to the wavelength range of infrared rays absorbed by the gas fall within the light transmission range.

Reflector 8 is put on upper surface 4 of support 5. Reflector 8 is formed from a metallic plate material having a rectangular flat shape. Reflector 8 has a smooth surface capable of reflecting infrared rays. Reflector 8 integrates main section 25 having a rectangular shape and projections 26 having a rectangular shape smaller than main section 25 and protruding externally from both ends of main section 25. Reflector 8 has first opening 15 in a first end part of main section 25 to allow infrared rays from light emitting element 6 to pass through. Reflector 8 has a pair of insertion holes 14 in the first end part of main section 25. Reflector 8 has second openings 16 in a second end part of main section 25 so that infrared rays transmitted through the second openings can be received by light receiving element 7. Reflector 8 has insertion hole 14 in projection 26 adjacent to the second end part. Reflector 8 blocks the opening in frame-shaped support 5. Reflector 8 covers the opening in frame-shaped support 5.

Optical component 10 is a synthetic resin molded part having interior surface 27 and exterior surface 28 and is covered upper surface 4 of support 5 on which reflector 8 is put. Optical component 10 is plated with metal and hence metal coating 29 is formed entirely on interior and exterior surfaces 27 and 28 of optical component 10. Interior surface 27 of optical component 10 is covered light emitting element 6 and light receiving elements 7. In planar view, optical component 10 is shaped like a rectangular parallelepiped that is substantially equal in outside diameter to support 5. Optical component 10 includes a recess having an opening adjacent to support 5 and abutting on interior surface 27. The recess in optical component 10 constitutes optical path 11 into which a gas subject to detection is introduced. In optical component 10, metal coating 29 forms first reflecting mirror 30, second reflecting mirror 31, and third reflecting mirror 32 on interior surface 27. First reflecting mirror 30 is disposed on a first side of optical component 10. Light emitted from light emitting element 6 is reflected off first reflecting mirror 30. Second reflecting mirror 31 is disposed on a second side of the optical component. Light reflected off first reflecting mirror 30 is reflected off second reflecting mirror 31 toward light receiving element 7. Third reflecting mirror 32 is disposed between first and second reflecting mirrors 30 and 31. Out of rays of light reflected off first reflecting mirror 30, rays of light that have not been reflected in a direction parallel to upper surface 4 of substrate 2 are reflected off third reflecting mirror 32 so as to be guided toward second reflecting mirror 31. First and second reflecting mirrors 30 and 31 each have a radial plane shape and are configured such that light is readily concentrated onto light receiving element 7. Third reflecting mirror 32 is formed so as to be parallel to upper surface 4 of substrate 2. Support 5 and optical component 10 can be aligned with each other by projections 13. This configuration enables light emitting element 6 to be disposed such that the light emitting element is put in proper alignment with a focal point on a reflective surface of first reflecting mirror 30. This configuration also enables light receiving elements 7 to be disposed such that the light receiving elements are put in proper alignment with a focal point on a reflective surface of second reflecting mirror 31. Optical component 10 is a part molded from a synthetic resin. However, optical component 10 may be formed from a metallic material. Metal coating 29 may be put only on interior surface 27 other than entirely on interior and exterior surfaces 27 and 28 of optical component 10. Because of formation of metal coating 29 only on interior surface 27, optical component 10 can be plated with a decreased amount of a metallic material. This contributes to a reduction in cost of device 1. If metal plating is to be applied only to interior surface 27, a plating process may involve plating only interior surface 27 with a metallic material. Alternatively, optical component 10 may be a two-color molded part so that a segment of optical component 10 contiguous to interior surface 27 and a segment of optical component 10 contiguous to exterior surface 28 are made from different materials and that the material for the segment contiguous to interior surface 27 is readily plated with metal and the material for the segment contiguous to exterior surface 28 is hard to be plated with metal. For example, if a segment of optical component 10 contiguous to interior surface 27 is formed from acrylonitrile-butadiene-styrene (ABS) resin and a segment contiguous to exterior surface 28 is formed from a polycarbonate, only interior surface 27 can be plated with metal. Optical component 10 having this composition provides improved flame resistance compared to optical component 10 made entirely from ABS resin because ABS resin is highly inflammable in contrast with the flame-resistant polycarbonate.

Optical component 10 has rectangular air vents 33 passing through in a thickness direction of optical component 10. Optical component 10 is designed to introduce a gas subject to detection into a space through air vents 33. Storage recess 35 in optical component 10 is provided with dust filter 34 to cover air vents 33 of optical component 10. Dust filter 34 inhibits dust and other foreign substances from entering into air vents 33. Dust filter 34 is fastened to storage recess 35 with an adhesive agent (not shown).

Device 1 introduces outside air into a space enclosed with optical component 10 and reflector 8 through air vents 33. In device 1, out of infrared rays emitted from light emitting element 6, an amount of infrared rays passing through first optical filter 23 and being received by first light receiving element 21 decreases in response to a variation in the concentration of a gas subject to detection. In device 1, the amount of infrared rays received by first light receiving element 21 is near the amount of infrared rays emitted from light emitting element 6 if the concentration of the gas subject to detection is low. The amount of infrared rays received by first light receiving element 21 decreases along with an increase in the concentration of the gas subject to detection. In device 1, the amount of infrared rays passing through second optical filter 24 and being received by second light receiving element 22 does not change in response to a variation in the concentration of the gas subject to detection.

In device 1, light receiving element 7 sends a signal with an intensity in response to the amount of infrared rays it has received and signal processing circuit 17 performs signal processing on the signal. Device 1 can detect the concentration of a gas constituent subject to detection in the space enclosed with optical component 10 and reflector 8.

In device 1 according to the present exemplary embodiment, signal processing circuit 17 computes the concentration of a gas subject to detection based on a difference between levels of signals sent from the pair of light receiving elements 7. Signal processing circuit 17 takes a difference between levels of signals sent from first light receiving element 21 and second light receiving element 22 and computes the concentration of the subject gas based on the difference. This configuration enables device 1 to offset a variation in the level of signals sent from each light receiving element 7 based on a difference between the levels of signals sent from first light receiving element 21 and second light receiving element 22. This in turn prevents the accuracy in detecting gas concentration from decreasing.

If signal processing circuit 17 in device 1 computes the concentration of a gas based on only the level of signals sent from one light receiving element 7, the accuracy in detecting the concentration of the gas may decrease in the case of the occurrence of a variation in the level of signals sent from light receiving element 7 due to an extraneous disturbance factor. In device 1 according to the present exemplary embodiment, signal processing circuit 17 computes the concentration of a gas subject to detection based on a difference between levels of signals sent from the pair of light receiving elements 7. This configuration enables the device to offset a variation in the level of signals sent from respective light receiving elements 7 and thereby prevents the accuracy in detecting gas concentration from decreasing.

Optical filter 12 is a component that infrared rays in a predetermined wavelength band are permitted to pass through. Optical filter 12 is a bandpass filter having a light transmission range. A band of wavelengths including the wavelengths of infrared rays emitted from light emitting element 6 falls within the light transmission range. Optical filter 12 is, for example, an interference filter formed of a multilayer dielectric film. Examples of the base material for optical filter 12 include germanium (Ge), silicon (Si) and other semiconductor materials, and methacrylate resins. Optical filter 12 is disposed on step parts 20 of support 5. Optical filter 12 may be fastened to step parts 20 of support 5 with a bonding agent (not shown). Optical filter 12 may be fastened to reflector 8 with a bonding agent. Optical filter 12 may be attached to light receiving element 7 with a bonding agent. Examples of the bonding agent include low melting glass, low melting alloys, and resin materials. In device 1 according to the present exemplary embodiment, optical filter 12 may be disposed on a portion of optical component 10 between first reflecting mirror 30 and second reflecting mirror 31, for example. In other words, the disposition of optical filter 12 is satisfactory, with proviso that the optical filter is disposed in optical path 11 guiding infrared rays emitted from light emitting element 6 toward light receiving element 7.

In device 1 according to the exemplary embodiment, support 5 is formed from a conductive material such as a metallic material. Projections 13 of support 5 are electrically connected to insertion holes 14 of reflector 8 by a conductive bonding agent, with the projections inserted into the insertion holes. Support 5 is electrically connected to ground 36 in substrate 2 by a conductive bonding agent. As a result, reflector 8 is electrically connected to ground 36 in substrate 2. This configuration enables reflector 8 to have a shield effect and thus contributes to a reduction in the influence of noise on electronic components 3 put on substrate 2. In device 1, support 5 is formed of a conductive component and hence support 5 has a shield effect. This contributes to a further reduction in the influence of noise on electronic components 3.

In device 1 according to the exemplary embodiment, optical component 10 is electrically connected to ground 36 in substrate 2 via reflector 8. This allows reflector 8 to be electrically connected to ground 36 of substrate 2 without disposition of a separate part for directly connecting optical component 10 to ground 36 of substrate 2. This enables optical component 10 to come down in size as compared with a conventional structure in which optical component 10 is directly connected to ground 36 of substrate 2. This contributes to a reduction in the quantity of metal used for plating optical component 10. Downsized optical component 10 provides a reduction in the quantity of a resin used for forming optical component 10. This configuration eliminates the need for the disposition of a nonessential part on optical component 10 to connect with ground 36 of substrate 2 and hence facilitates the molding of optical component 10.

### Second Exemplary Embodiment

Device 41 according to a second exemplary embodiment will now be described with reference to the drawings. Description is primarily given on differences between the device and device 1 of the first exemplary embodiment.

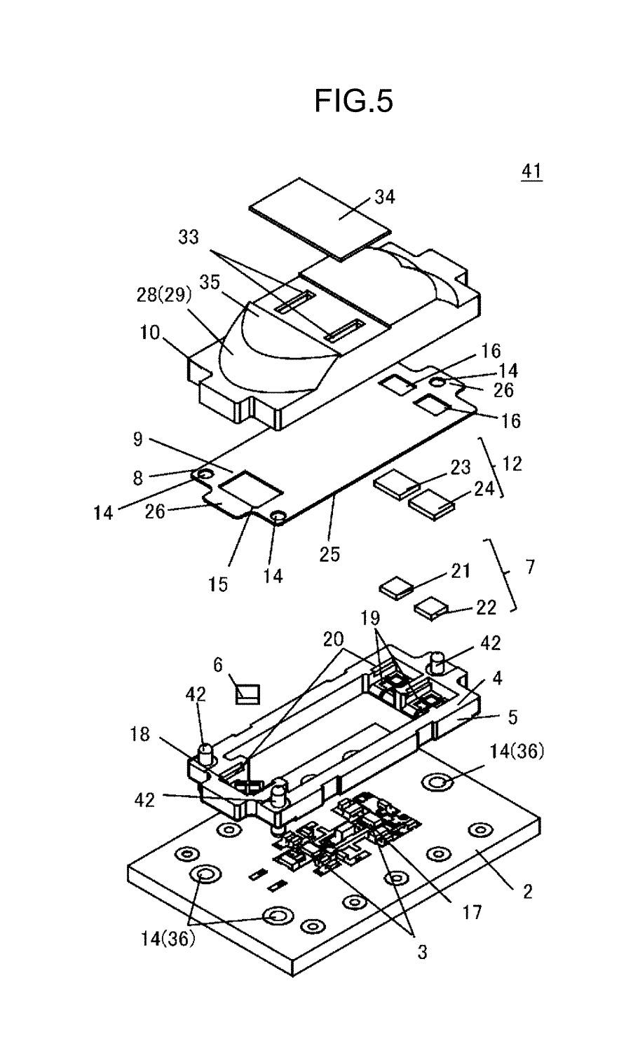

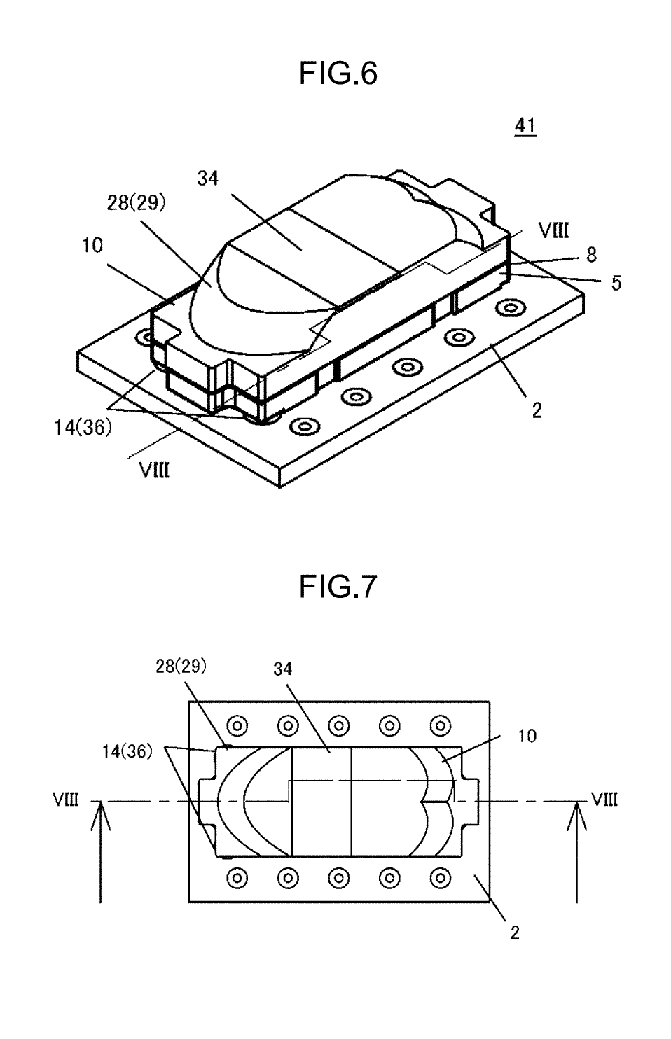

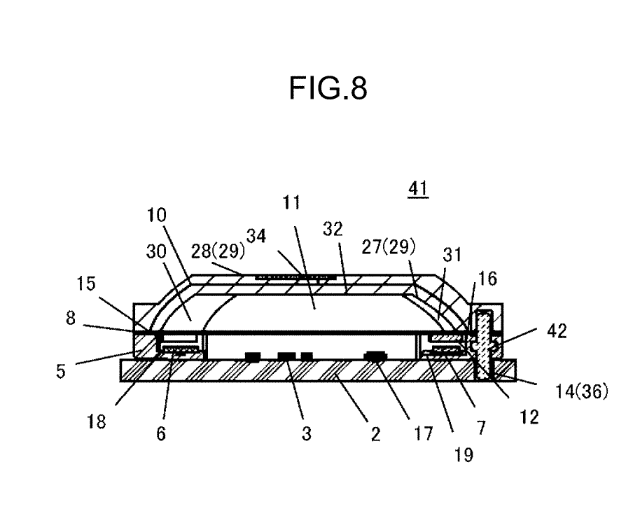

FIG. 5 is an exploded perspective view of device 41 according to the second exemplary embodiment. FIG. 6 is a perspective view of device 41. FIG. 7 is a top view of device 41. FIG. 8 is a cross-sectional view of device 41 taken from line VIII-VIII.

Device 41 according to the second exemplary embodiment includes substrate 2, electronic component 3 disposed on substrate 2, support 5 being disposed so as to surround electronic component 3 and having upper surface 4, light emitting element 6 and light receiving element 7 that are disposed on support 5, reflector 8 disposed on upper surface 4 of support 5, and optical component 10 disposed on upper surface 9 of reflector 8. Device 41 further includes optical filter 12 disposed in optical path 11 guiding infrared rays emitted from light emitting element 6 toward light receiving element 7. Infrared rays in a predetermined wavelength band are permitted to pass through optical filter 12.

In device 41, support 5 is a part molded from a synthetic resin. Support 5 has conductive pins 42 that are formed by insert molding such that inserted pins 42 are integrated with support 5. Reflector 8 is electrically connected to ground 36 in substrate 2 via the pins and hence reflector 8 has a shield effect. This configuration contributes to a reduction in the influence of noise on electronic component 3. Since reflector 8 is electrically connected to ground 36 of substrate 2 by metal-made pins 42, device 41 provides improved thermal resistance for connection of substrate 2 to pins 42. Device 41 has a plurality of the pins, which are designed to connect reflector 8 with ground 36 of substrate 2 through holes disposed near one end and another end of reflector 8. This configuration smooths unevenness in potential difference across reflector 8, resulting in an improvement in the shield effect of reflector 8.

### Third Exemplary Embodiment

Device 51 according to a third exemplary embodiment will now be described with reference to the drawings. Description is primarily given on differences between the device and device 1 of the first exemplary embodiment.

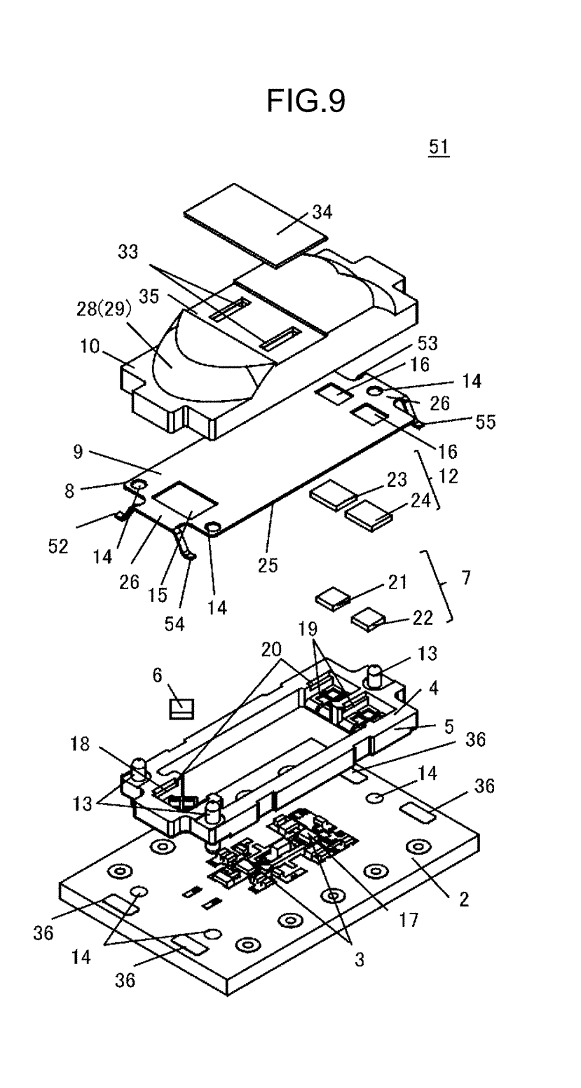

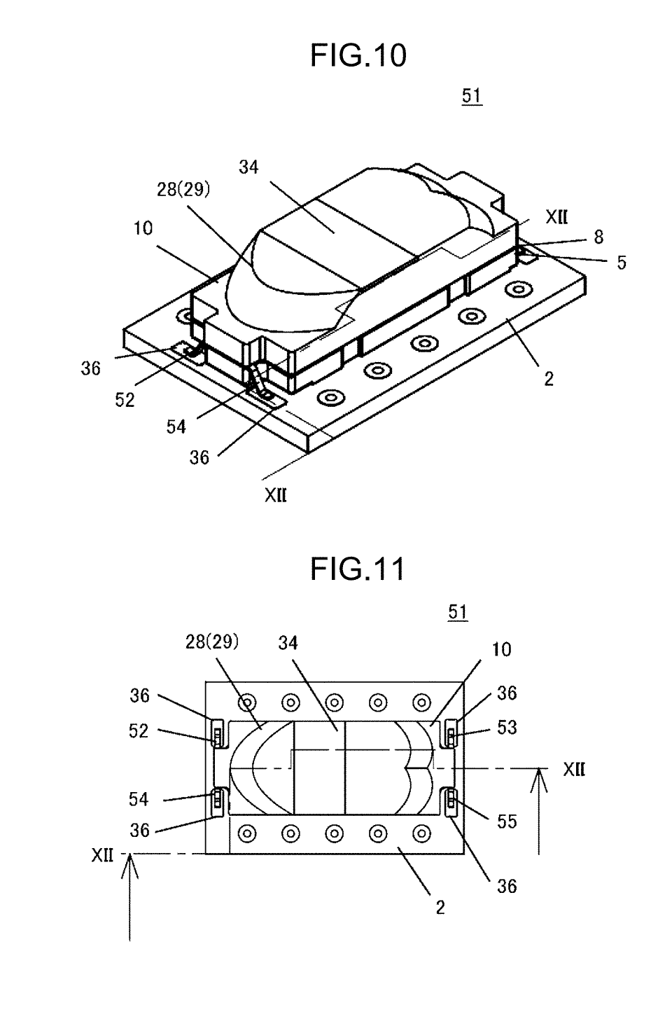

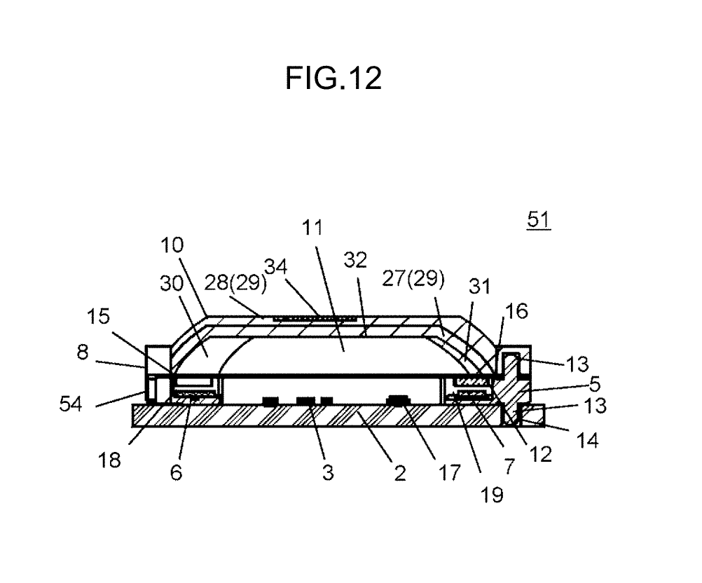

FIG. 9 is an exploded perspective view of device 51 according to the third exemplary embodiment. FIG. 10 is a perspective view of device 51. FIG. 11 is a top view of device 51. FIG. 12 is a cross-sectional view of device 51 taken from line XII-XII.

Device 51 according to the third exemplary embodiment includes substrate 2, electronic component 3 disposed on substrate 2, support 5 being disposed so as to surround electronic component 3 and having upper surface 4, light emitting element 6 and light receiving element 7 that are disposed on support 5, reflector 8 disposed on upper surface 4 of support 5, and optical component 10 disposed on upper surface 9 of reflector 8. Device 51 further includes optical filter 12 disposed in optical path 11 guiding infrared rays emitted from light emitting element 6 toward light receiving element 7. Infrared rays in a predetermined wavelength band are permitted to pass through optical filter 12. Support 5 is provided with projections 13. Substrate 2, reflector 8, and optical component 10 each have insertion holes 14.

In device 51, reflector 8 is provided with first terminal 52, second terminal 53, third terminal 54, and fourth terminal 55 for connecting to ground 36 in substrate 2. First and third terminals 52 and 54 are disposed on a first end of reflector 8, whereas second and fourth terminals 53 and 55 are disposed on a second end of reflector 8. In device 1, the reflector is connected to ground 36 of substrate 2 by first, second, third, and fourth terminals 52, 53, 54, and 55. This configuration enables reflector 8 to have a shield effect and thus contributes to a reduction in the influence of noise on electronic component 3. Reflector 8 can produce a shield effect even if reflector 8 is connected to ground 36 of substrate 2 by one terminal. Since reflector 8 is connected to ground 36 of substrate 2 by first, second, third, and fourth terminals 52, 53, 54, and 55, device 51 smooths unevenness in potential difference across reflector 8, and thus provides an improvement in the shield effect of reflector 8. In device 51 of the present exemplary embodiment, reflector 8 is firmly connected to ground 36 of substrate 2 by first, second, third, and fourth terminals 52, 53, 54, and 55. However, reflector 8 may be connected to ground 36 by first and second terminals 52 and 53 other than the four terminals described above. This allows device 51 to be formed in a simpler configuration. Device 51 according to the present exemplary embodiment provides improved thermal resistance for connection of substrate 2 to first and second terminals 52 and 53 since the reflector is connected to ground 36 of substrate 2 by first and second terminals 52 and 53 formed of metal.

First and second terminals 52 and 53 may be spring terminals.

### Fourth Exemplary Embodiment

Device 61 according to a fourth exemplary embodiment will now be described with reference to the drawings. Description is primarily given on differences between the device and device 1 of the first exemplary embodiment.

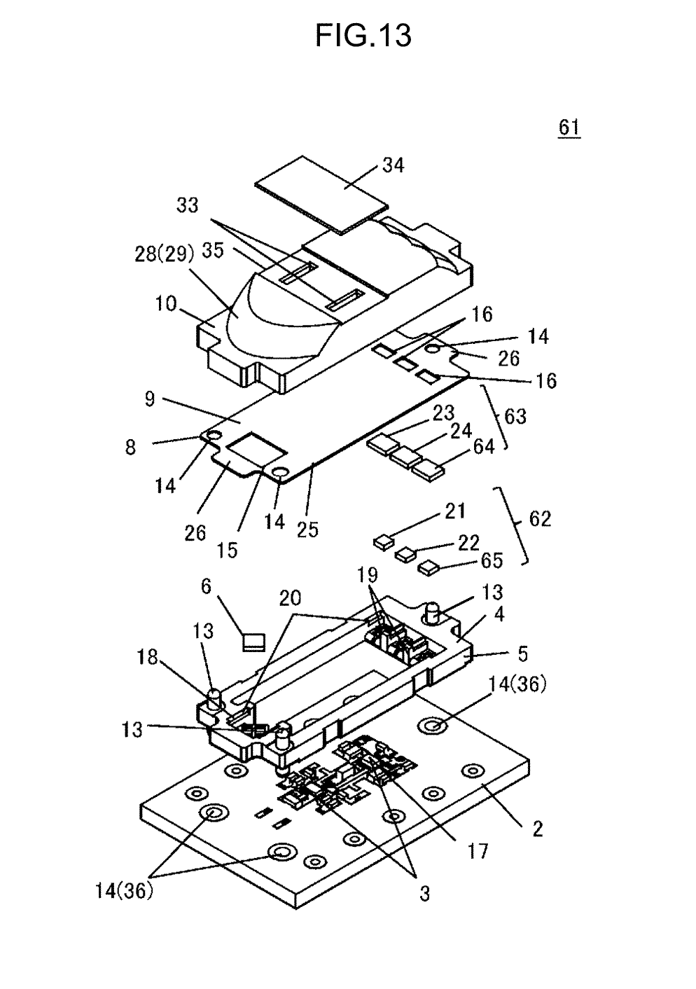

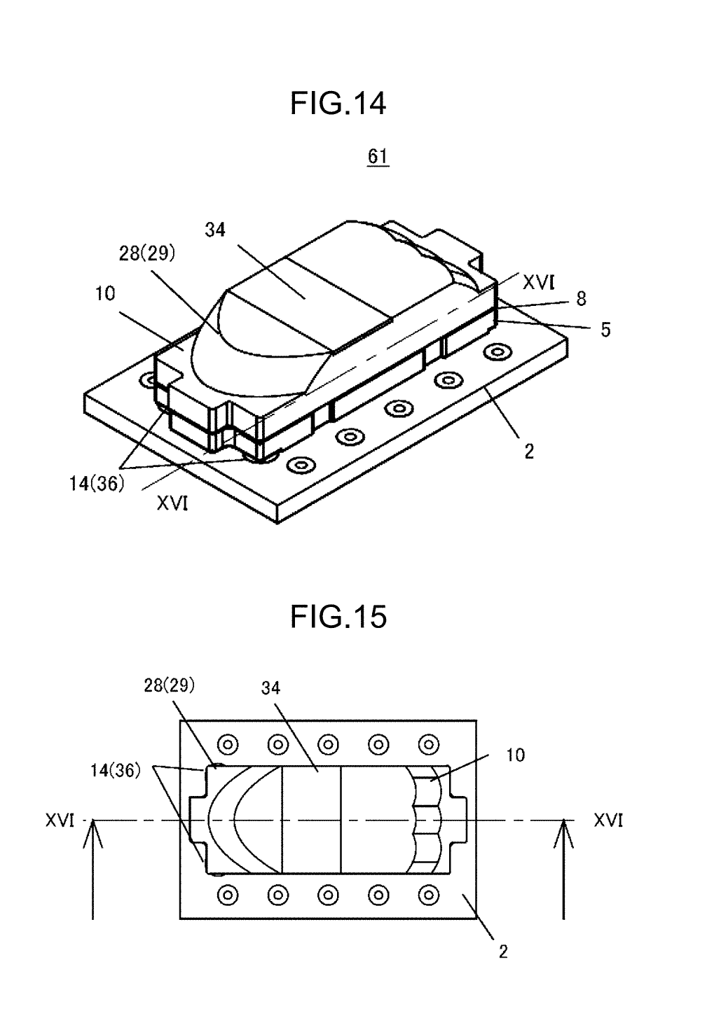

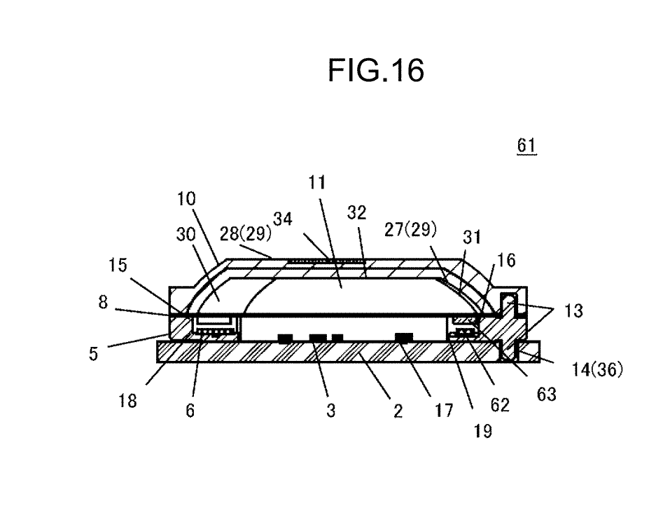

FIG. 13 is an exploded perspective view of device 61 according to the fourth exemplary embodiment. FIG. 14 is a perspective view of device 61. FIG. 15 is a top view of device 61. FIG. 16 is a cross-sectional view of device 61 taken from line XVI-XVI.

Device 61 includes substrate 2, electronic component 3 disposed on substrate 2, support 5 being disposed so as to surround electronic component 3 and having upper surface 4, light emitting element 6 and light receiving element 62 that are disposed on support 5, reflector 8 disposed on upper surface 4 of support 5, and optical component 10 disposed on upper surface 9 of reflector 8. Device 61 further includes optical filter 63 disposed in optical path 11 guiding infrared rays emitted from light emitting element 6 toward light receiving element 62. Infrared rays in a predetermined wavelength band are permitted to pass through optical filter 63. Support 5 is provided with projections 13. Substrate 2, reflector 8, and optical component 10 each have insertion holes 14. Projections 13 are inserted into insertion holes 14 in substrate 2, reflector 8, and optical component 10, and these components are fastened by soldering (not shown). Projections 13 enable substrate 2, reflector 8, and optical component 10 to be put in proper alignment with support 5. Support 5 is, in common with the support in the first exemplary embodiment, formed of a conductive component, and reflector 8 is connected to ground 36 in substrate 2 through support 5. This configuration enables reflector 8 to produce a shield effect and thus contributes to a reduction in the influence of noise on electronic component 3.

Optical filter 63 includes first optical filter 23, second optical filter 24, and third optical filter 64. Light receiving element 62 includes first light receiving element 21, second light receiving element 22, and third light receiving element 65.

Device 61 according to the present exemplary embodiment has this configuration and thus can detect plural kinds of gases. Device 1 of the first exemplary embodiment is an example of a gas sensor configured to detect the concentration of one kind of a gas contained in outside air. If light receiving element 62 and optical filter 63 include multiple sets of parts, a device incorporating these components is tantamount to a gas sensor that can detect concentrations of different kinds of gases with the sets of the parts. In device 61 of the present exemplary embodiment, light receiving element 62 and optical filter 63 include three or more sets of parts and hence the device can detect concentrations of different kinds of gases with signals output from the parts of light receiving element 62.

In device 61, the parts of optical filter 63 are bandpass filters having light transmission ranges. Wavelengths corresponding to absorption characteristics of gases subject to detection fall within the respective light transmission ranges. This enables the device to detect plural kinds of gases. Device 61 has three parts in light receiving element 62 and thus can detect concentrations of two different kinds of gases independently among plural kinds of gases. For example, the device can simultaneously detect carbon dioxide as a first gas and a nitrogen oxide as a second gas. Device 61 has third optical filter 64. Infrared rays in a wavelength band that are not absorbed by any of the first gas and the second gas are permitted to pass through the third optical filter. Third light receiving element 65 receives infrared rays that are transmitted through third optical filter 64, converts received light energy into electric signals, and sends the signals to signal processing circuit 17. Signal processing circuit 17 measures a rate of change in intensity of light emitted form light emitting element 6 over a period starting initial light emission on the basis of signals sent from third light receiving element 65. In device 61, signal processing circuit 17, which measures the rate of change in light intensity over a period starting initial emission of light from light emitting element 6, corrects signals sent from first light receiving element 21 and second light receiving element 22. By correcting signals sent from first and second light receiving elements 21 and 22, device 61 removes influences such as degradation in power of light emitting element 6 and thereby provides improved measurement accuracy.

Device 61 according to the fourth exemplary embodiment includes support 5 formed of a conductive component and hence establishes electrical connection with ground 36 in substrate 2. Alternatively, the device may have pins 42 that are formed by insert molding as with device 41 of the second exemplary embodiment. The device of the present exemplary embodiment may have terminals on reflector 8 as with device 51 of the third exemplary embodiment.

### Fifth Exemplary Embodiment

Device 71 according to a fifth exemplary embodiment will now be described with reference to the drawings. Description is primarily given on differences between the device and device 1 of the first exemplary embodiment.

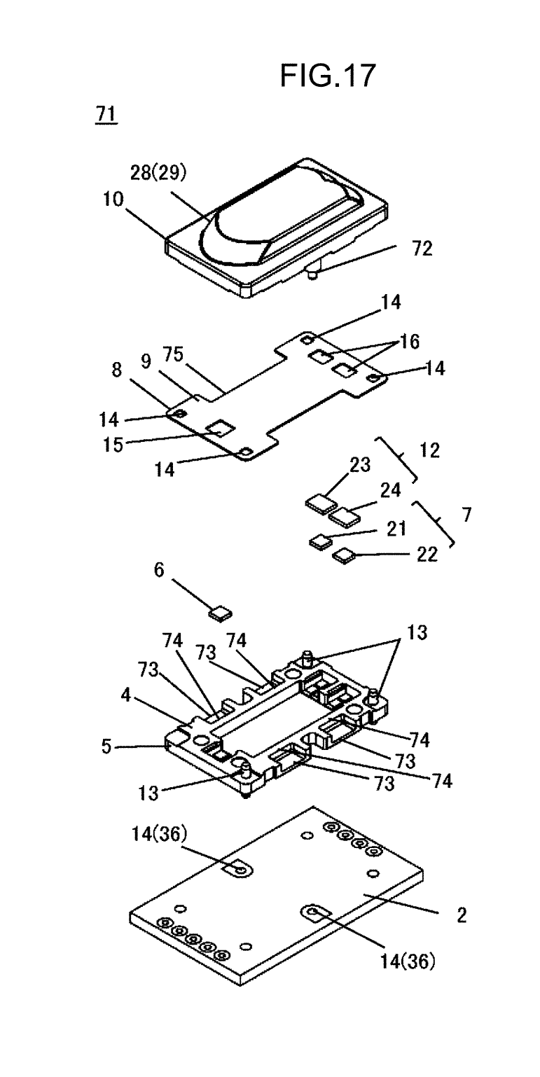

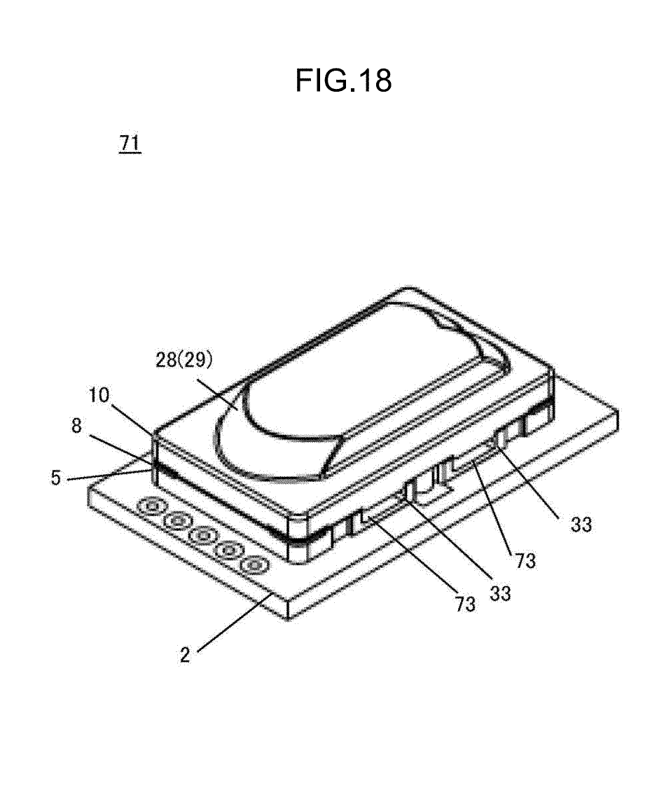

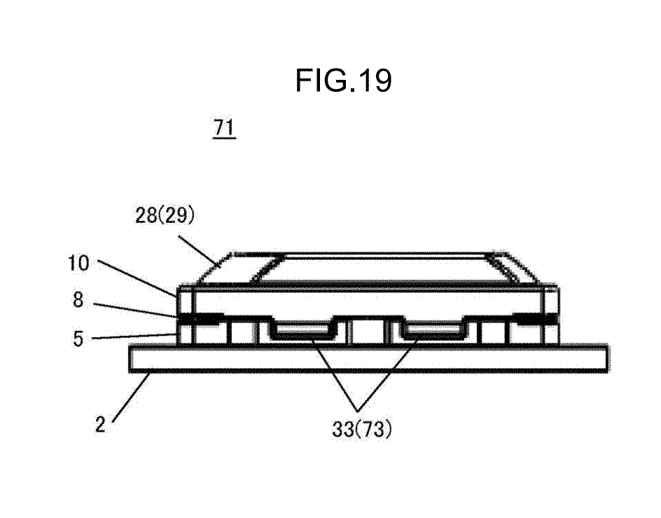

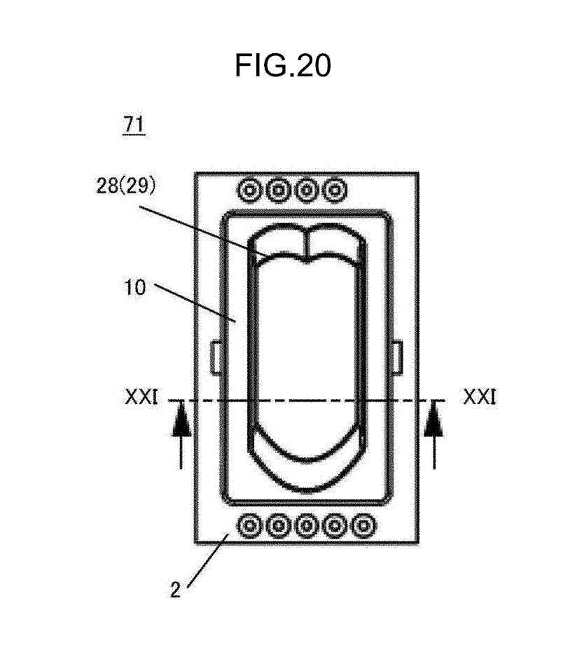

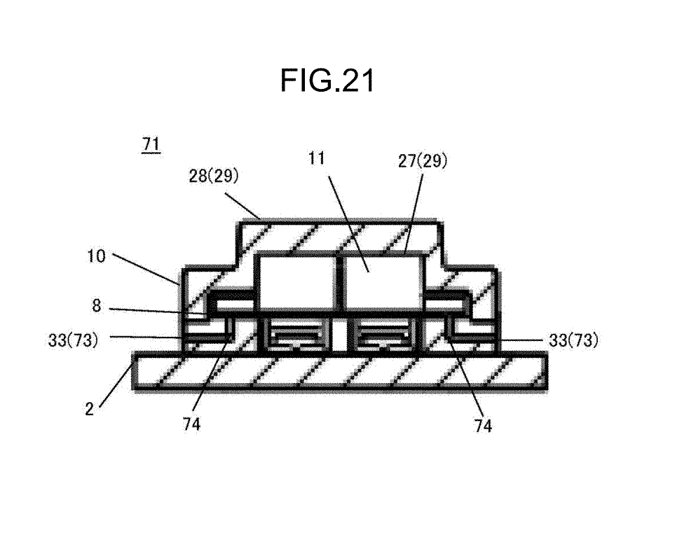

FIG. 17 is an exploded perspective view of a device according to the fifth exemplary embodiment. FIG. 18 is a perspective view of the device. FIG. 19 is a side view of the device. FIG. 20 is a top view of the device. FIG. 21 is a cross-sectional view of the device taken from line XXI-XXI.

Device 71 includes substrate 2, an electronic component (not shown) disposed on substrate 2, support 5 being disposed so as to surround the electronic component and having upper surface 4, light emitting element 6 and light receiving element 7 that are disposed on support 5, reflector 8 disposed on upper surface 4 of support 5, and optical component 10 disposed on upper surface 9 of reflector 8. Device 71 further includes optical filter 12 disposed in optical path 11 guiding infrared rays emitted from light emitting element 6 toward light receiving element 7. Infrared rays in a predetermined wavelength band are permitted to pass through optical filter 12. Optical component 10 includes bosses 72 inserted into insertion holes 14 in substrate 2. A surface of boss 72 is plated with metal in common with interior surface 27 of optical component 10. A periphery of insertion hole 14 is provided with ground 36. As a result, optical component 10 is electrically connected to ground 36 through bosses 72 inserted into insertion holes 14. Interior surface 27 of optical component 10 is plated with the metal. A segment of optical component 10 plated with the metal is in contact with reflector 8 and hence optical component 10 and reflector 8 are at an identical electric potential. Consequently, reflector 8 is electrically connected to ground 36. This configuration enables reflector 8 to produce a shield effect and thus contributes to a reduction in the influence of noise on the electronic component. Bosses 72 are integrated with optical component 10, and hence bosses 72 are used to hold optical component 10 and reflector 8 onto substrate 2 and establish electric connection between reflector 8 and substrate 2. This configuration contributes to a reduction in a number of components of device 71 and an improvement in productivity.

Device 71 has a lateral surface between an upper surface and a lower surface of the device. The lateral surface of device 71 has air vents 33. Air vents 33 are formed owing to disposition of lateral surface recesses 73 on support 5. Two lateral surface recesses 73 are disposed on each of opposed side faces of the support. Lateral surface recesses 73 of support 5 have respective step portions 74. Parts of reflector 8 corresponding to step portions 74 are dented inward such that reflector recesses 75 are formed and step portions 74 are formed on support 5. This configuration, due to the disposition of step portions 74, prevents dust and other foreign substances from entering into device 71. This prevents the entry of dust without any dust filter. This configuration contributes to a reduction in the number of components of device 71 and an improvement in productivity.

### INDUSTRIAL APPLICABILITY

The technique used for the devices according to the present disclosure provides a highly sensitive and highly selective sensor. This technique can be applied to various sensors such as fluid sensors and is especially suitable for detecting concentrations of hydrocarbon gases and other gases with low boiling points. Because of the suitability for detecting hydrocarbon gases and other gases, a sensor according to the present disclosure is suitable for applications such as detection of a concentration of carbon dioxide indoors, detection of refrigerant leakage from a car air conditioner using a carbon dioxide refrigerant, and detection of a concentration of an ingredient of fuel for an automobile.

### REFERENCE MARKS IN THE DRAWINGS

1, 41, 51, 61, 71: device

2: substrate

3: electronic component

4, 9: upper surface

5: support

6: light emitting element

7, 62: light receiving element

8: reflector

10: optical component

11: optical path

12, 63: optical filter

13: projection

14: insertion hole

15: first opening

16: second opening

17: signal processing circuit

18: first recess

19: second recess

20: step part

21: first light receiving element

22: second light receiving element

23: first optical filter

24: second optical filter

25: main section

26: projection

27: interior surface

28: exterior surface

29: metal coating

30: first reflecting mirror

31: second reflecting mirror

32: third reflecting mirror

33: air vent

34: dust filter

35: storage recess

36: ground

42: pin

52: first terminal

53: second terminal

54: third terminal

55: fourth terminal

64: third optical filter

65: third light receiving element

72: boss

73: lateral surface recess

74: step portion

75: reflector recess

1. A device comprising:
a light emitting element;
a light receiving element;
an electronic component to process signals sent from the light receiving element;
an optical component covered the light emitting element and the light receiving element;
a reflector covering a lower surface of the optical component, the reflector having a first opening facing the light emitting element and a second opening facing the light receiving element; and
a substrate over which the light emitting element, the light receiving element, the reflector, the electronic component, and the optical component are mounted,
wherein the reflector is electrically connected to the substrate by a member disposed between the reflector and the substrate.

2. The device according to claim 1, further comprising
a support between the substrate and the reflector,
wherein the light emitting element, the light receiving element, and the reflector are disposed on the support, and
the electronic component is directly mounted on the substrate.

3. The device according to claim 2, wherein
the support has a lateral surface put between the optical component and the substrate, and
the lateral surface has an air vent.

4. The device according to claim 3, wherein a step portion is disposed inside the air vent.

5. The device according to claim 2, wherein
the support comprises a conductive material, and
the reflector is electrically connected to the substrate by the support.

6. The device according to claim 2, further comprising a conductive pin inserted into the optical component, the reflector, the support, and the substrate,
wherein the reflector is electrically connected to the substrate by the pin.

7. The device according to claim 6, wherein the pin is integrated with the support.

8. The device according to claim 1, wherein the reflector has a first terminal electrically connecting the substrate with the reflector.

9. The device according to claim 8, further comprising a second terminal, wherein
the reflector has a first end and a second end opposed to the first end in planar view,
the first terminal is disposed on the first end of the reflector, and
the second terminal is disposed on the second end of the reflector to electrically connect the substrate with the reflector.

10. The device according to claim 9, wherein the first terminal and the second terminal are spring terminals.

11. The device according to claim 1, wherein
the optical component further includes a boss connecting the substrate with the optical component, and
the reflector is electrically connected to the substrate by the boss.

12. The device according to claim 1, wherein an upper surface of the light emitting element and an upper surface of the light receiving element are higher in position than an upper surface of the electronic component.

13. The device according to claim 1, wherein the upper surface of the light emitting element and the upper surface of the light receiving element are lower in position than an upper surface of the reflector.

14. The device according to claim 1, wherein
the optical component has a first end and a second end opposed to the first end in planar view, and
the light emitting element is disposed adjacent to the first end, and the light receiving element is disposed adjacent to the second end.

15. The device according to claim 1, wherein the optical component comprises a metallic material that is electrically connected to the reflector.

16. The device according to claim 15, wherein
the optical component includes an inner surface cover both the light emitting element and the light receiving element and an outer surface opposed to the inner surface, and
the metallic material is disposed only on the inner surface of the optical component.

17. The device according to claim 1, wherein the optical component includes a first reflecting mirror directly above the light emitting element, a second reflecting mirror directly above the light receiving element, and a third reflecting mirror disposed between the first reflecting mirror and the second reflecting mirror.

18. The device according to claim 1, wherein light emitted from the light emitting element is reflected off the first reflecting mirror toward the second reflecting mirror, and the reflected light is reflected off the second reflecting mirror toward the light receiving element.
